(19) United States
(12) Patent Application Publication
(10) Pub. No.: US 2022/0128870 A1
(43) Pub. Date: Apr. 28, 2022

(54) DISPLAY SUBSTRATE AND DISPLAY PANEL

(71) Applicants: BEIJING BOE DISPLAY TECHNOLOGY CO., LTD., Beijing (CN); BOE TECHNOLOGY GROUP CO., LTD., Beijing (CN)

(72) Inventors: Tianxin ZHAO, Beijing (CN); Ji DONG, Beijing (CN); Shijun WANG, Beijing (CN); Zhiying BAO, Beijing (CN); Ruichen ZHANG, Beijing (CN); Hao LIU, Beijing (CN); Xiaoqing PENG, Beijing (CN); Jiao LI, Beijing (CN); Wenjun XIAO, Beijing (CN); Hao XU, Beijing (CN); Bo FENG, Beijing (CN); Xiaoxiao CHEN, Beijing (CN); Yang WANG, Beijing (CN); Wenkai MU, Beijing (CN); Bingqing YANG, Beijing (CN); Yi LIU, Beijing (CN); Haoliang JI, Beijing (CN)

(21) Appl. No.: 16/954,133

(22) PCT Filed: Jul. 24, 2019
(86) PCT No.: PCT/CN2019/097489

§ 371 Date: Jun. 15, 2020

(51) Int. Cl. G02F 1/1343; G02F 1/1362

(52) U.S. Cl. CPC G02F 1/134336; G02F 2202/16; G02F 1/136286

(57) ABSTRACT

The present disclosure provides a display substrate and a display panel, which belong to the field of display technologies. The display substrate includes: a base substrate; a signal line layer and a pixel electrode layer which are on one side of the base substrate and are insulated and spaced from each other. The signal line layer includes a plurality of signal lines, the pixel electrode layer includes a plurality of pixel electrodes arranged in an array. An orthographic projection of the pixel electrode to the base substrate overlaps an orthographic projection of at least one signal line to the base substrate. The technical solution of the present disclosure can improve the transmittance of the display device.

TECHNICAL FIELD

The present disclosure relates to the field of display technologies, and in particular to a display substrate and a display panel.

### BACKGROUND

Transmittance of a liquid crystal display (LCD) panel plays an extremely important role in overall display performance of the liquid crystal display panel. The higher the transmittance, the higher a displayable brightness of the liquid crystal display panel, and the lower a brightness of a backlight source, thereby reducing production cost of products. Therefore, the industry has been trying to improve the transmittance of LCD panels.

### SUMMARY

The technical problem to be solved by the present disclosure is to provide a display substrate and a display panel, which can improve transmittance of the display device.

In order to solve the above technical problems, embodiments of the present disclosure provide technical solutions as follows.

In one aspect, a display substrate is provided, including:

a base substrate;

a signal line layer and a pixel electrode layer which are on one side of the base substrate and are insulated and spaced from each other; wherein the signal line layer includes a plurality of signal lines, the pixel electrode layer includes a plurality of pixel electrodes arranged in an array;

wherein an orthographic projection of the pixel electrode to the base substrate overlaps an orthographic projection of at least one signal line to the base substrate.

Optionally, the plurality of signal lines includes data lines; there is a first overlapping area between the orthographic projection of the pixel electrode to the base substrate and an orthographic projection of each of two data lines adjacent the pixel electrode to the base substrate.

Optionally, the plurality of signal lines includes gate lines; there is a second overlapping area between the orthographic projection of the pixel electrode to the base substrate and an orthographic projection of each of two gate lines adjacent the pixel electrode to the base substrate.

The first overlapping area has a width d of 0.5-1.0 μm in a first direction; the first direction is perpendicular to an extension direction of the data line and parallel to the base substrate.

The second overlapping area has a width d of 0.5-1.0 μm in a second direction; the second direction is perpendicular to an extension direction of the gate line and parallel to the base substrate.

Optionally, the display substrate further includes:

a transparent conductive layer between the pixel electrode layer and the signal line layer;

wherein the transparent conductive layer includes a transparent conductive pattern;

wherein the orthographic projection of the signal line to the base substrate is within an orthographic projection of the transparent conductive pattern to the base substrate.

Optionally, the plurality of signal lines includes data lines; an orthographic projection of the data line to the base substrate falls into the orthographic projection of the transparent conductive pattern to the base substrate; there is a third overlapping area between the orthographic projection of the pixel electrode to the base substrate and the orthographic projection of the transparent conductive pattern to the base substrate; a width of the third overlapping area in a first direction is not less than 1.5 μm; the first direction is perpendicular to an extension direction of the data line and parallel to the base substrate.

Optionally, the plurality of signal lines includes data lines; the plurality of signal lines includes gate lines; an orthographic projection of the gate line to the base substrate falls into the orthographic projection of the transparent conductive pattern to the base substrate; there is a fourth overlapping area between the orthographic projection of the pixel electrode to the base substrate and the orthographic projection of the transparent conductive pattern to the base substrate; a width of the fourth overlapping area in a second direction is not less than 1.5 pm; the second direction is perpendicular to an extension direction of the gate line and parallel to the base substrate.

Optionally, the transparent conductive pattern is a whole layer.

One embodiment of the present disclosure further provides a display panel including: the above display substrate; a counter substrate disposed opposite to the display substrate; wherein the display substrate and the counter substrate define a cell; and, a liquid crystal layer between the display substrate and the counter substrate.

Optionally, the display substrate further includes:

a transparent conductive layer between the pixel electrode layer and the signal line layer, wherein the transparent conductive layer includes a transparent conductive pattern;

a common electrode;

wherein the transparent conductive pattern is electrically coupled with the common electrode.

### BRIEF DESCRIPTION OF THE DRAWINGS

FIG. 1 is a schematic plan view of a display substrate in the related art;

FIG. 2 is a schematic cross-sectional view of a display panel taken along a line CC shown in FIG. 1 in the related art;

FIG. 3 is a schematic plan view of a display substrate according to an embodiment of the present disclosure;

FIG. 4 is a schematic cross-sectional view of a display panel taken along a line CC shown in FIG. 3 according to an embodiment of the present disclosure;

FIG. 5 is a schematic cross-sectional view of a display panel taken along a line DD shown in FIG. 3 according to an embodiment of the present disclosure;

FIG. 6 is a schematic plan view of a display substrate according to another embodiment of the present disclosure;

FIG. 7 is a schematic cross-sectional view of a display panel taken along a line CC shown in FIG. 6 according to another embodiment of the present disclosure;

FIG. 8 is a schematic cross-sectional view of a display panel taken along a line CC shown in FIG. 6 according to another embodiment of the present disclosure;

FIG. 9 is a schematic cross-sectional view of a display panel taken along a line DD shown in FIG. 6 according to another embodiment of the present disclosure; and

FIG. 10 is a schematic diagram of a display device according to an embodiment of the present disclosure.

### REFERENCE NUMERALS

1 base substrate
2 gate insulating layer
3 first passivation layer
5 pixel electrode
6 liquid crystal layer
7 common electrode
9 base substrate
10 black matrix
11 data line
13 second passivation layer
14 transparent conductive pattern
15 gate line
16 first display panel
17 second display panel

### DETAILED DESCRIPTION

In order to make the technical problems to be solved, the technical solutions and the advantages of the present disclosure more apparent, the present disclosure will be described hereinafter in a clear and complete manner in conjunction with the drawings and embodiments.

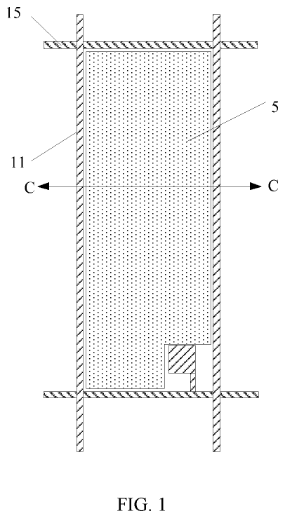

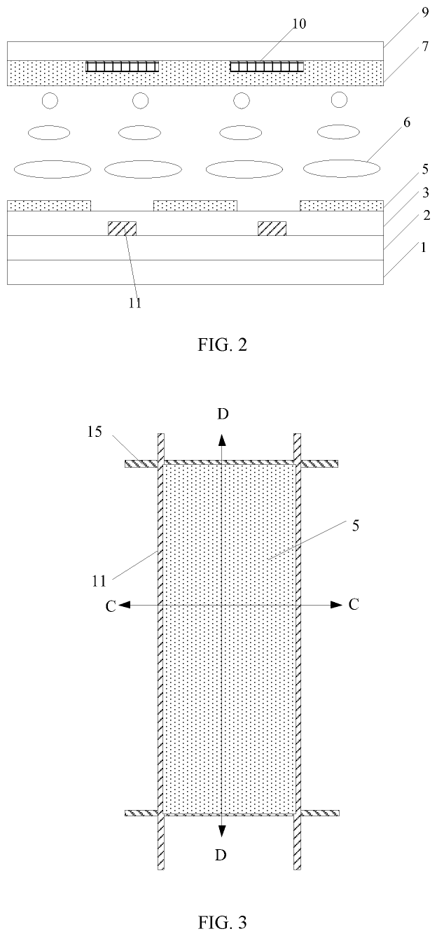

In the related art, in order to improve the contrast of a display screen, a display device may be composed of two stacked display panels. One display panel at a light emitting side is a main display panel which may be referred as a main cell, and is used to display a colorful screen. The other display panel is a sub-display panel which may be referred as a sub cell, and is used to adjust the backlight. Most of the sub-display panels employ vertical electric field type liquid crystal display panels as shown in FIG. 1 and FIG. 2.

As shown in FIG. 1 and FIG. 2, on a display substrate, gate lines 15 and data lines 11 cross each other to define a plurality of pixel regions. A pixel electrode 5 is located in the pixel region. There is a gap between the pixel electrode 5 and signal lines (including the gate line 15 and the data line 11). A driving electric field between the pixel electrode 5 and a common electrode 7 does not exist at this gap. When a LCD panel is in operation, liquid crystals at this gap will not deflect as expected.

Since the liquid crystal display panel employs a backlight source to provide backlight, uncontrollable light leakage occurs at this gap. In order to block the light leakage of the display substrate, a black matrix 10 with a relatively large width needs to be provided on a counter substrate to block the light leakage, which results in a lower transmittance of the sub-display panel, and then resulting in a lower transmittance of the display device.

In order to solve the above problem, embodiments of the present disclosure provide a display substrate and a display panel, which can improve transmittance of a display device.

One embodiment of the present disclosure provides a display substrate including a signal line layer and a pixel electrode layer which are on one side of a base substrate and are insulated and spaced from each other. The signal line layer includes a plurality of signal lines. The pixel electrode layer includes a plurality of pixel electrodes arranged in an array. An orthographic projection of the pixel electrode to the base substrate overlaps an orthographic projection of at least one signal line to the base substrate.

In this embodiment, there is an overlapping area between the orthographic projection of the pixel electrode to the base substrate and the orthographic projection of at least one signal line to the base substrate. At a position where the overlapping area exists, there is no gap between the orthographic projection of the pixel electrode to the base substrate and the orthographic projection of the signal line to the base substrate. A driving electric field is generated between the pixel electrode and a common electrode and can deflect liquid crystals. Then, when the display substrate is displaying, the liquid crystals corresponding to the overlapping area can be deflected under action of the driving electric field, thereby avoiding uncontrolled light leakage. In this way, it is not necessary to provide a black matrix with a relatively large width at a corresponding position of a counter substrate to block light leakage, and thus the transmittance of the display panel can be improved and then transmittance of the display device can be improved.

The signal line layer includes a gate line layer and a data line layer. The gate line layer includes a plurality of gate lines. The data line layer includes a plurality of data lines.

The display substrate in this embodiment may be applied to a sub-display panel of a display device including dual display panels. A black matrix and a color filter unit are provided in a main display panel of the display device. Since the main display panel still has a black matrix, this can prevent ambient light from irradiating on thin film transistors of the sub-display panel, which affects the performance of the thin film transistors. Thus, there is no need to provide a black matrix on the sub-display panel, and then the black matrix of the sub-display panel can be omitted.

Optionally, there is a first overlapping area between the orthographic projection of the pixel electrode to the base substrate and an orthographic projection of each of two data lines adjacent the pixel electrode to the base substrate. In this way, there is no gap between the orthographic projection of the pixel electrode to the base substrate and the orthographic projection of each of data lines adjacent the pixel electrode to the base substrate. The driving electric field generated between the pixel electrode and the common electrode can deflect liquid crystals. Then, when the display substrate is displaying, it can avoid uncontrollable light leakage between the pixel electrode and its adjacent data lines.

Optionally, there is a second overlapping area between the orthographic projection of the pixel electrode to the base substrate and an orthographic projection of each of two gate lines adjacent the pixel electrode to the base substrate. In this way, there is no gap between the orthographic projection of the pixel electrode to the base substrate and the orthographic projection of each of gate lines adjacent the pixel electrode to the base substrate. The driving electric field generated between the pixel electrode and the common electrode can deflect liquid crystals. Then, when the display substrate is displaying, it can avoid uncontrollable light leakage between the pixel electrode and its adjacent gate lines.

Specifically, in order to avoid light leakage to the greatest extent, at each of four edges of the pixel region, the orthographic projection of the pixel electrode to the base substrate extends in an area of the orthographic projection area of the signal line to the base substrate. In other words, at each of the four edges of the pixel region, there is an overlapping area between the orthographic projection of the pixel electrode to the base substrate and the orthographic projection of each gate line adjacent the pixel electrode to the base substrate, and there is an overlapping area between the orthographic projection of the pixel electrode to the base substrate and the orthographic projection of each data line adjacent the pixel electrode to the base substrate. It is worth noting that the orthographic projection of the pixel electrode to the base substrate does not extend to an adjacent pixel region or contact with an adjacent pixel electrode. An extension size of the pixel electrode is determined by a width of the overlapping area. A value of the width of the overlapping area may be set according to actual needs, as long as no uncontrollable light leakage occurs on the display substrate and there is a certain distance between adjacent pixel electrodes.

In one specific embodiment, there is a first overlapping area between the orthographic projection of the pixel electrode to the base substrate and the orthographic projection of each data line adjacent the pixel electrode to the base substrate. The first overlapping area has a width d of 0.5-1.0 μm in a first direction. The first direction is perpendicular to an extension direction of the data line and parallel to the base substrate. When the width d takes the above value, it can ensure that no uncontrollable light leakage occurs between the pixel electrode and the adjacent data line, as well as that there is a certain distance between adjacent pixel electrodes.

There is a second overlapping area between the orthographic projection of the pixel electrode to the base substrate and the orthographic projection of each gate line adjacent the pixel electrode to the base substrate. The second overlapping area has a width d of 0.5-1.0 μm in a second direction. The second direction is perpendicular to an extension direction of the gate line and parallel to the base substrate. When the width d takes the above value, it can ensure that no uncontrollable light leakage occurs between the pixel electrode and the adjacent gate line, as well as that there is a certain distance between adjacent pixel electrodes.

Since the signal lines are usually made of opaque metal, in order to ensure the transmittance of the display substrate, the size of the signal line in this embodiment is not increased as compared with the related art, and only the size of the pixel electrode is enlarged to ensure that there is an overlapping area between the orthographic projection of the pixel electrode to the base substrate and the orthographic projection of the signal line to the base substrate. Since the pixel electrodes are usually made of transparent conductive materials, enlarging the size of the pixel electrodes will not affect the transmittance of the display substrate.

According to the technical solution of the present disclosure, the transmittance of the display panel can be improved by more than 40%, and the display performance of the display substrate can be greatly improved.

In addition, since there is an overlapping area between the orthographic projection of the pixel electrode to the base substrate and the orthographic projection of the signal line to the base substrate, parasitic capacitance is generated between the signal line and the pixel electrode when the display substrate is in operation. Then, an electrical signal loaded in the signal line may affect an electrical signal in the pixel electrode, which causes fluctuations in the electrical signal in the pixel electrode and then results in flicker during displaying. In order to ensure the display performance, the display substrate in one embodiment further includes: a transparent conductive layer between the pixel electrode layer and the signal line layer, where the transparent conductive layer includes a transparent conductive pattern.

The orthographic projection of the signal line to the base substrate is within an orthographic projection of the transparent conductive pattern to the base substrate.

In this embodiment, the transparent conductive pattern is provided between the pixel electrode and the signal line, and the orthographic projection of the signal line to the base substrate is within an orthographic projection of the transparent conductive pattern to the base substrate; in this way, the transparent conductive pattern can shield the influence of the electrical signal in the signal line on the electrical signal in the pixel electrode, thereby preventing a display screen from flickering.

When the liquid crystal display panel is displaying, electrical signals are loaded on the gate line and the data line. The electrical signals loaded in the gate line and the data line will affect the pixel electrode. On the one hand, parasitic capacitance is generated between the pixel electrode and the gate line or the data line, which leads to disorder of liquid crystals. On the other hand, the electrical signals loaded in the gate line and the data line will affect also affect the electrical signal in the pixel electrode. In this embodiment, not only a transparent conductive pattern is provided between the data line and the pixel electrode, but also a transparent conductive pattern is provided between the gate line and the pixel electrode. In this way, the transparent conductive pattern can not only avoid the influence of the electrical signal in the data line on the pixel electrode, but also avoid the influence of the electrical signal in the gate line on the pixel electrode.

Since there is overlapping areas between the orthographic projection of the pixel electrode to the base substrate and the orthographic projection of the signal line to the base substrate, and the orthographic projection of the signal line to the base substrate is within an orthographic projection of the transparent conductive pattern to the base substrate, then there is an overlapping area between the orthographic projection of the pixel electrode to the base substrate and the orthographic projection of the transparent conductive pattern to the base substrate. In this way, when the transparent conductive pattern receives a common voltage signal, a storage capacitor can be generated between the transparent conductive pattern and the pixel electrode, which can further increase storage capacitance of the display substrate, reduce a value of Cpd/Ctotal and prevent crosstalk in the display screen. Ctotal includes Cpd, Cst and Cpg, where Cpd is capacitance between the pixel electrode and the data line, Cst is storage capacitance, Cpg is capacitance between the pixel electrode and the gate line. Since the transparent conductive pattern is located between the signal line and the pixel electrode, values of Cpd and Cpg can be reduced, and then the value of Cpd/Ctotal can be reduced. The transparent conductive pattern is made of transparent materials, which will not block light from passing through the display substrate and will not affect the transmittance of the display substrate.

The transparent conductive pattern may be coupled with a fixed potential output terminal of the display substrate. When the fixed potential output terminal outputs a common voltage signal, the transparent conductive pattern receives the common voltage signal. The transparent conductive pattern may also be electrically coupled with a common electrode, so that the transparent conductive pattern can receive the common voltage signal when the display substrate is in operation.

In order to maximize the storage capacitance between the transparent conductive pattern and the pixel electrode, the transparent conductive pattern may be made as a whole layer. When the transparent conductive pattern is a whole layer structure without hollowed-out regions, a whole layer of transparent conductive material can be directly formed as the transparent conductive pattern without having to pattern the transparent conductive material, which can reduce the number of patterning processes for the display substrate. In addition, when the transparent conductive pattern is a whole layer, the transparent conductive pattern is also located between the pixel electrode and thin film transistors of the display substrate. Then, the transparent conductive pattern can also shield the influence of electrical signals in the thin film transistors on the pixel electrode, thereby further optimizing the display performance. It is worth noting that when the signal line and the pixel electrode at two sides of the transparent conductive pattern are needed to be connected via hole in the display substrate, via holes need to be reserved in the transparent conductive pattern, and then other regions except for the region including the via hole in the transparent conductive pattern is a whole layer.

The transparent conductive pattern may not be a whole layer. In one specific embodiment, an elongated transparent conductive pattern is provided between the pixel electrode and the data line. The orthographic projection of the data line to the base substrate falls into the orthographic projection of the transparent conductive pattern to the base substrate. There is a third overlapping area between the orthographic projection of the pixel electrode to the base substrate and the orthographic projection of the transparent conductive pattern to the base substrate. The size of the storage capacitance increased by the transparent conductive pattern is determined by a width of the third overlapping area in the first direction. The first direction is perpendicular to the extension direction of the data line and parallel to the base substrate. In order to ensure the storage capacitance of the liquid crystal display panel and prevent the display screen from flickering, the width of the third overlapping area in the first direction is not less than 1.5 μm.

In another specific embodiment, an elongated transparent conductive pattern is provided between the pixel electrode and the gate line. The orthographic projection of the gate line to the base substrate falls into the orthographic projection of the transparent conductive pattern to the base substrate. There is a fourth overlapping area between the orthographic projection of the pixel electrode to the base substrate and the orthographic projection of the transparent conductive pattern to the base substrate. The size of the storage capacitance increased by the transparent conductive pattern is determined by a width of the fourth overlapping area in the second direction. The second direction is perpendicular to the extension direction of the gate line and parallel to the base substrate. In order to ensure the storage capacitance of the liquid crystal display panel and prevent the display screen from flickering, the width of the fourth overlapping area in the second direction is not less than 1.5 μm.

Electrodes of the thin film transistors in the display substrate are usually made of opaque metal. In order to ensure the transmittance of the display substrate, this embodiment can reduce the size of the thin film transistor as compared with the related art. In addition, at a position in the data line corresponding to the thin film transistor, a line width of the data line can be adjusted to avoid the thin film transistor. After the line width of the data line is adjusted, it is necessary to ensure that there is still an overlapping area between the orthographic projection of the data line to the base substrate and the orthographic projection of the pixel electrode to the base substrate.

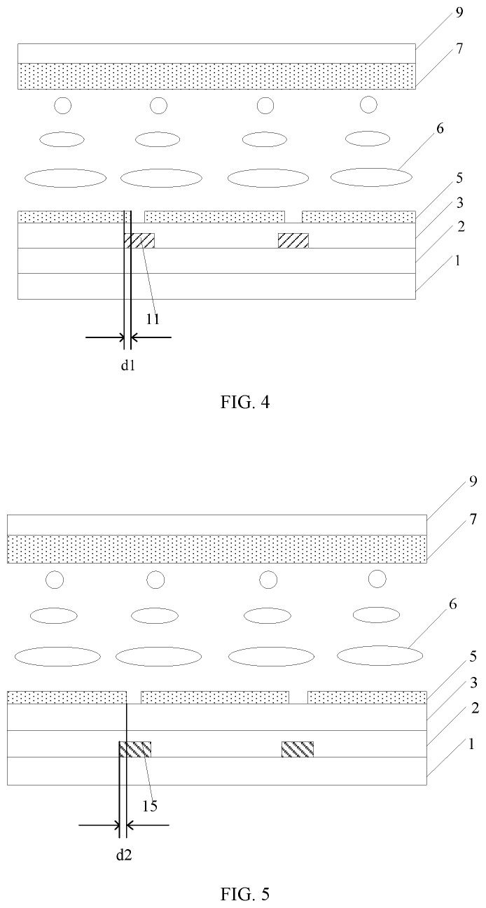

In one specific embodiment, as shown in FIG. 3 to FIG. 5, a display substrate according to one embodiment of the present disclosure specifically includes: a base substrate 1; a gate line 15, a common electrode line, and a gate electrode (not shown) of a thin film transistor gate on the base substrate 1; a gate insulating layer 2 covering the gate line 15, the common electrode line and the gate; a data line 11 and an active layer, a source electrode and a drain electrode (not shown) of the thin film transistor on one side of the gate insulating layer 2 away from the gate line 15; a first passivation layer 3 covering the data line 11, the active layer, the source electrode and the drain electrode; and a pixel electrode 5 on one side of the first passivation layer 3 away from the data line 11. Compared with the related art, a size of the pixel electrode 5 in this embodiment is enlarged. There is an overlapping area between an orthographic projection of the pixel electrode 5 to the base substrate and an orthographic projection of each of the data line 11 and the gate line 15 to the base substrate. As shown in FIG. 4, there is a first overlapping area between the orthographic projection of the pixel electrode 5 to the base substrate 1 and the orthographic projection of the data line 11 to the base substrate 1. The first overlapping area has a width of d1 in a first direction. As shown in FIG. 5, there is a second overlapping area between the orthographic projection of the pixel electrode 5 to the base substrate 1 and the orthographic projection of the gate line 15 to the base substrate 1. The second overlapping area has a width of d2 in a second direction. Values of d1 and d2 may be set according to actual needs, as long as no uncontrollable light leakage occurs on the display substrate and there is a certain distance between adjacent pixel electrodes.

In this embodiment, since there is an overlapping area between the orthographic projection of the pixel electrode 5 to the base substrate and the orthographic projection of each of the data line 11 and the gate line 15 to the base substrate, this can avoid uncontrollable light leakage on the display substrate. Therefore, a black matrix can be omitted on a counter substrate. As shown in FIG. 4 and FIG. 5, the counter substrate includes only a base substrate 9 and a common electrode 7, which can improve the transmittance of the display panel.

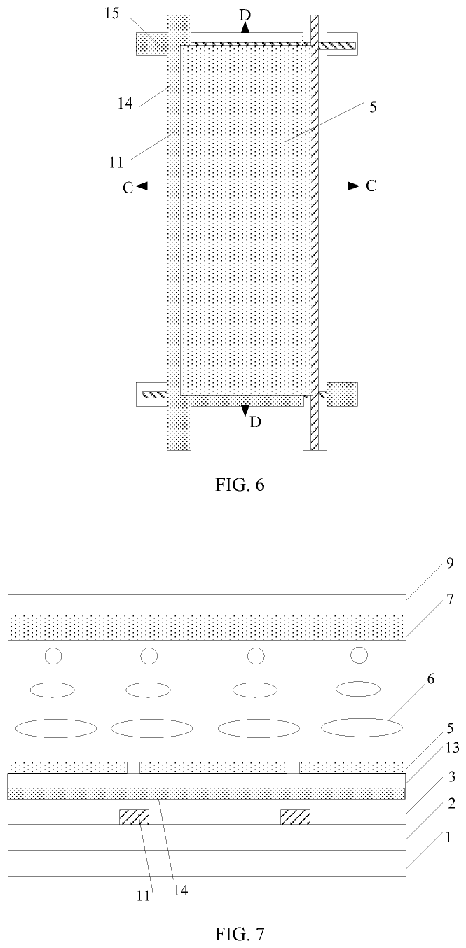

In another specific embodiment, as shown in FIG. 6 to FIG. 9, a display substrate according to one embodiment of the present disclosure specifically includes: a base substrate 1; a gate line 15, a common electrode line and a gate electrode (not shown) of a thin film transistor on the base substrate 1; a gate insulating layer 2 covering the gate line 15, the common electrode line and the gate electrode; a data line 11 and an active layer, a source electrode and a drain electrode (not shown) of the thin film transistor on one side of the gate insulating layer 2 away from the gate line 15; a first passivation layer 3 covering the data line 11, the active layer, the source electrode and the drain electrode; a transparent conductive pattern 14 on one side of the first passivation layer 3 away from the data line 11; a second passivation layer 13 covering the transparent conductive pattern 14; a pixel electrode 5 on one side of the second passivation layer 13 away from the transparent conductive pattern 14.

In one embodiment, the transparent conductive pattern 14 is added between the pixel electrode 5 and each of the data line 11 and the gate line 15. When the display panel is in operation, the transparent conductive pattern 14 receives a common voltage signal, which can shield the gate line 15 and the data line 11. On the one hand, this can avoid parasitic capacitance generated between the pixel electrode 5 and each of the gate line 15 and the data line 11. On the other hand, this can avoid the influence of the electrical signals in the gate line 15 and the data line 11 on the electrical signal in the pixel electrode 5, thereby preventing disorder of liquid crystals which causes light leakage. In addition, a storage capacitor can be generated between the transparent conductive pattern and the pixel electrode 5, thereby increasing the storage capacitance of the display substrate and providing sufficient storage capacitance for the display substrate.

As shown in FIG. 7, the transparent conductive pattern 14 may be a whole layer. In this way, the storage capacitance between the transparent conductive pattern 14 and the pixel electrode 5 can be maximized. In addition, since a whole layer of transparent conductive material can be directly formed as a transparent conductive pattern without having to pattern the transparent conductive material, thereby reducing the number of patterning processes for the display substrate. In addition, when the transparent conductive pattern 14 is a whole layer, the transparent conductive pattern 14 is also located between the pixel electrode 5 and the thin film transistor of the display substrate. Then the transparent conductive pattern 14 can also shield the influence of the electrical signal in the thin film transistor on the pixel electrode 5, thereby further optimizing the display performance.

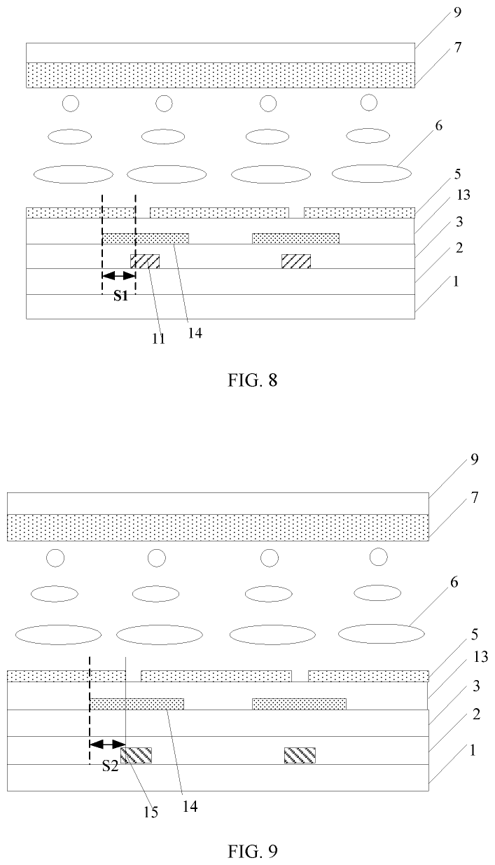

The transparent conductive pattern may not be a whole layer. When the transparent conductive pattern is not a whole layer, as shown in FIG. 8, the transparent conductive pattern 14 may only occupy a partial area of the display substrate.

As shown in FIG. 8, an extension direction of one part of the transparent conductive pattern 14 may be identical to an extension direction of the data line 11. An orthographic projection of the data line 11 to the base substrate 1 falls into an orthographic projection of the one part of the transparent conductive pattern 14 to the base substrate 1. There is a third overlapping area between the orthographic projection of the one part of the transparent conductive pattern 14 to the base substrate 1 and the orthographic projection of the pixel electrode 5 to the base substrate 1. The third overlapping area has a width S1 in the first direction. At this point, the size of the storage capacitance increased by the one part of the transparent conductive pattern 14 is determined by S1. In order to ensure the storage capacitance of the liquid crystal display panel and prevent the display screen from flickering, the width S1 of the third overlapping area may be not less than 1.5 μm.

As shown in FIG. 9, an extension direction of one portion of the transparent conductive pattern 14 may be identical to an extension direction of the gate line 15. An orthographic projection of the gate line 15 to the base substrate 1 falls into an orthographic projection of the one portion of the transparent conductive pattern 14 to the base substrate 1. There is a fourth overlapping area between the orthographic projection of the one portion of the transparent conductive pattern 14 to the base substrate 1 and the orthographic projection of the pixel electrode 5 to the base substrate 1. The fourth overlapping area has a width S2 in the second direction. At this point, the size of the storage capacitance increased by the one portion of the transparent conductive pattern 14 is determined by S2. In order to ensure the storage capacitance of the liquid crystal display panel and prevent the display screen from flickering, the width S2 of the fourth overlapping area may be not less than 1.5 μm.

Specifically, the transparent conductive pattern 14 may be coupled with a common electrode line in a different layer through a connection structure in a via hole. A common voltage signal is input to the transparent conductive pattern 14 through the common electrode line. When the transparent conductive pattern only occupies a partial area of the display substrate, a connection structure may be set for each transparent conductive pattern, so that each transparent conductive pattern is coupled with the common electrode line through the connection structure. When the transparent conductive pattern 14 is a whole layer, one or more connection structures may be set on the whole display substrate to connect the transparent conductive pattern 14 with the common electrode line.

One embodiment of the present disclosure further provides a display panel, which includes the above display substrate, a counter substrate disposed opposite to the display substrate, and a liquid crystal layer between the display substrate and the counter substrate.

In this embodiment, there is an overlapping area between the orthographic projection of the pixel electrode to the base substrate and the orthographic projection of at least one signal line to the base substrate. At a position where the overlapping area exists, there is no gap between the orthographic projection of the pixel electrode to the base substrate and the orthographic projection of the signal line to the base substrate. A driving electric field is generated between the pixel electrode and a common electrode and can deflect liquid crystals. Then, when the display substrate is displaying, the liquid crystals corresponding to the overlapping area can be deflected under action of the driving electric field, thereby avoiding uncontrolled light leakage. In this way, it is not necessary to provide a black matrix with a relatively large width at a corresponding position of the counter substrate to block light leakage, and thus the transmittance of the display panel can be improved and then transmittance of the display device can be improved.

The display panel in this embodiment may be applied to a display device including dual display panels, or may be applied to a display device including only one display panel, to increase the transmittance of the display device.

When the display panel in this embodiment is applied to a display device including dual display panels, the display panel in this embodiment may be used as a sub-display panel for the display device.

Since a main display panel still has a black matrix, it can prevent light from irradiating on thin film transistor of the sub-display panel, which affects the performance of the thin film transistors. Thus, eliminating the black matrix of the sub-display panel will not affect the display of the display device.

Optionally, the display substrate further includes:

a transparent conductive layer between the pixel electrode layer and the signal line layer, where the transparent conductive layer includes a transparent conductive pattern;

a common electrode, where the transparent conductive pattern is electrically coupled with the common electrode.

The materials of the common electrode and transparent conductive pattern may be the same. For example, the common electrode and transparent conductive pattern may made of ITO. In this way, an identical film-forming equipment can be used to form a common electrode material layer and a transparent conductive pattern material layer.

In the technical solution of the present disclosure, when the display panel is displaying, an electrical signal of the same voltage may be input to the transparent conductive pattern and the common electrode. Specifically, the voltage of the electrical signal may be 0 V.

The transparent conductive pattern may be coupled with a fixed potential output terminal of the display substrate. When the fixed potential output terminal outputs a common voltage signal, the transparent conductive pattern receives the common voltage signal. The transparent conductive pattern may also be electrically coupled with the common electrode, so that the transparent conductive pattern can receive the common voltage signal when the display substrate is in operation.

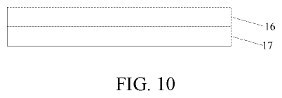

One embodiment of the present disclosure further provides a display device. As shown in FIG. 10, the display device includes a first display panel 16 and a second display panel 17 that are stacked on each other. The first display panel 16 is located at a light emitting side of the second display panel 17. The second display panel 17 employs the above display panel.

In this embodiment, since the transmittance of the second display panel is improved, under the condition that the first display panel remains unchanged, image quality is not affected and the transmittance of the display device is improved.

The first display panel may be used as a main display panel, and the second display panel may be used as a sub-display panel. A black matrix and a color filter unit are provided in the first display panel. Since the first display panel still has a black matrix, it can prevent light from irradiating on thin film transistors of the sub-display panel, which affects the performance of the thin film transistors. Thus, eliminating the black matrix of the second display panel will not affect the display of the display device.

The display device includes but not limited to, a radio frequency unit, a network module, an audio output unit, an input unit, a sensor, a display unit, a user input unit, an interface unit, a memory, a processor, and a power supply. Those skilled in the art may understand that the structure of the above display device does not constitute a limitation to the display device, and the display device may include more or less of the above components, or combine certain components, or arrange different components. In one embodiment of the present disclosure, the display device includes but not limited to, a display monitor, a mobile phone, a tablet computer, a television, a wearable electronic device, a navigation display device, and the like.

The display device may be any product or component having a display function such as a liquid crystal television, a liquid crystal display device, a digital photo frame, a mobile phone, a tablet computer. The display device further includes a flexible circuit board, a printed circuit board and a back plate.

It should be noted that the embodiments in this specification are described in a progressive manner. The same or similar parts between the embodiments can be referred to each other. Each embodiment focuses on differences from other embodiments. In particular, for the method embodiments, since they are basically similar to the product embodiments and thus the description thereof is relatively simple, and the relevant parts can be referred to the description of the product embodiments.

Unless otherwise defined, any technical or scientific terms used herein shall have the common meaning understood by a person of ordinary skills. Such words as “first” and “second” used in the specification and claims are merely used to differentiate different components rather than to represent any order, number or importance. Such words as “comprises” or “include” mean that an element or object appearing before the word covers elements or objects listed after the word and their equivalents, but do not exclude other elements or objects. Similarly, such words as “connect” or “connected to” may include electrical connection, direct or indirect, rather than being limited to physical or mechanical connection. Such words as “on/above”, “under/below”, “left” and “right” are merely used to represent relative position relationship, and when an absolute position of an object is changed, the relative position relationship will be changed too.

It will be understood that when an element such as a layer, film, region, or substrate is referred to as being “on” or “under” another element, this element may be “directly” on or “under” the other element, or, there may be an intermediate element therebetween.

In the description of the above embodiments, specific features, structures, materials or characteristics may be combined in any suitable manner in any one or more embodiments or examples.

The above are merely the embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure. The protection scope of the present disclosure shall be subject to the protection scope of the claims.

1. A display substrate comprising:
a base substrate;
a signal line layer and a pixel electrode layer which are on one side of the base substrate and are insulated and spaced from each other; wherein the signal line layer includes a plurality of signal lines, the pixel electrode layer includes a plurality of pixel electrodes arranged in an array;
wherein an orthographic projection of the pixel electrode to the base substrate overlaps an orthographic projection of at least one signal line to the base substrate.

2. The display substrate according to claim 1, wherein the plurality of signal lines includes data lines;
there is a first overlapping area between the orthographic projection of the pixel electrode to the base substrate and an orthographic projection of each of two data lines adjacent the pixel electrode to the base substrate.

3. The display substrate according to claim 2, wherein the plurality of signal lines includes gate lines;
there is a second overlapping area between the orthographic projection of the pixel electrode to the base substrate and an orthographic projection of each of two gate lines adjacent the pixel electrode to the base substrate.

4. The display substrate according to claim 3, wherein
the first overlapping area has a width d of 0.5-1.0 μm in a first direction; the first direction is perpendicular to an extension direction of the data line and parallel to the base substrate;
the second overlapping area has a width d of 0.5-1.0 μm in a second direction; the second direction is perpendicular to an extension direction of the gate line and parallel to the base substrate.

5. The display substrate according claim 1, wherein the display substrate further includes:
a transparent conductive layer between the pixel electrode layer and the signal line layer;
wherein the transparent conductive layer includes a transparent conductive pattern;
wherein the orthographic projection of the signal line to the base substrate is within an orthographic projection of the transparent conductive pattern to the base substrate.

6. The display substrate according to claim 5, wherein the plurality of signal lines includes data lines; an orthographic projection of the data line to the base substrate falls into the orthographic projection of the transparent conductive pattern to the base substrate; there is a third overlapping area between the orthographic projection of the pixel electrode to the base substrate and the orthographic projection of the transparent conductive pattern to the base substrate; a width of the third overlapping area in a first direction is not less than 1.5 μm; the first direction is perpendicular to an extension direction of the data line and parallel to the base substrate.

7. The display substrate according to claim 5, wherein the plurality of signal lines includes data lines; the plurality of signal lines includes gate lines; an orthographic projection of the gate line to the base substrate falls into the orthographic projection of the transparent conductive pattern to the base substrate; there is a fourth overlapping area between the orthographic projection of the pixel electrode to the base substrate and the orthographic projection of the transparent conductive pattern to the base substrate; a width of the fourth overlapping area in a second direction is not less than 1.5 μm; the second direction is perpendicular to an extension direction of the gate line and parallel to the base substrate.

8. The display substrate according to claim 6, wherein the transparent conductive pattern is a whole layer.

9. A display panel comprising:
a display substrate;
a counter substrate disposed opposite to the display substrate; wherein the display substrate and the counter substrate define a cell; and
a liquid crystal layer between the display substrate and the counter substrate;
wherein the display substrate includes:
a base substrate;
a signal line layer and a pixel electrode layer which are on one side of the base substrate and are insulated and spaced from each other; wherein the signal line layer includes a plurality of signal lines, the pixel electrode layer includes a plurality of pixel electrodes arranged in an array;
wherein an orthographic projection of the pixel electrode to the base substrate overlaps an orthographic projection of at least one signal line to the base substrate.

10. The display panel according to claim 9, wherein the display substrate further includes:
a transparent conductive layer between the pixel electrode layer and the signal line layer, wherein the transparent conductive layer includes a transparent conductive pattern;
a common electrode;
wherein the transparent conductive pattern is electrically coupled with the common electrode.

11. The display panel according to claim 9, wherein the plurality of signal lines includes data lines;
there is a first overlapping area between the orthographic projection of the pixel electrode to the base substrate and an orthographic projection of each of two data lines adjacent the pixel electrode to the base substrate.

12. The display panel according to claim 11, wherein the plurality of signal lines includes gate lines;
there is a second overlapping area between the orthographic projection of the pixel electrode to the base substrate and an orthographic projection of each of two gate lines adjacent the pixel electrode to the base substrate.

13. The display panel according to claim 12, wherein the first overlapping area has a width d of 0.5-1.0 μm in a first direction; the first direction is perpendicular to an extension direction of the data line and parallel to the base substrate;
the second overlapping area has a width d of 0.5-1.0 μm in a second direction; the second direction is perpendicular to an extension direction of the gate line and parallel to the base substrate.

14. The display panel according to claim 10, wherein the plurality of signal lines includes data lines; an orthographic projection of the data line to the base substrate falls into the orthographic projection of the transparent conductive pattern to the base substrate; there is a third overlapping area between the orthographic projection of the pixel electrode to the base substrate and the orthographic projection of the transparent conductive pattern to the base substrate; a width of the third overlapping area in a first direction is not less than 1.5 μm; the first direction is perpendicular to an extension direction of the data line and parallel to the base substrate.

15. The display panel according to claim 10, wherein the plurality of signal lines includes data lines; the plurality of signal lines includes gate lines; an orthographic projection of the gate line to the base substrate falls into the orthographic projection of the transparent conductive pattern to the base substrate; there is a fourth overlapping area between the orthographic projection of the pixel electrode to the base substrate and the orthographic projection of the transparent conductive pattern to the base substrate; a width of the fourth overlapping area in a second direction is not less than 1.5 μm; the second direction is perpendicular to an extension direction of the gate line and parallel to the base substrate.

16. The display panel according to claim 14, wherein the transparent conductive pattern is a whole layer.
